(19) United States
(12) Patent Application Publication
(10) Pub. No.: US 2005/0237634 A1
(43) Pub. Date: Oct. 27, 2005

(54) Magnification apparatus for hand-held power tools

(76) Inventor: Leonard Rothmann, Valencia, CA (US)

Correspondence Address: RANDALL L. OWEN, 24822 AVIGNON DRIVE, VALENCIA, CA, 91355, US

(21) Appl. No.: 10/832,146

(22) Filed: Apr. 24, 2004

(51) Int. Cl. G03B 27/74; G03B 27/80; G02B 7/02

(52) U.S. Cl. 359/811

(57) ABSTRACT

A novel magnification apparatus for power hand tools that allows working in confined workspaces is disclosed. In a first embodiment of the present invention, a magnification apparatus is attached to the top of the hand-held power tool using an adjustable friction mechanism that provides for an adjustment of the focus of the magnification apparatus. A tilt mechanism is also included that maintains the tool and workspace in the lens' field-of-view as the magnification apparatus is moved along the slot. This allows the operator to adjust the focus and magnification, thus allowing the clear viewing of the tools and workspace. In a second embodiment of the present invention, the magnification apparatus further includes a light for providing illumination in addition to magnification. The addition of the light in combination with the magnification apparatus increases the ability of the operator to view the tool and workspace, particularly in those cases where the workspace has poor ambient illumination.

### BACKGROUND OF THE INVENTION

1. Field of the Invention

The present invention relates to hand-held electric power tools, and more particularly to a magnification apparatus for allowing work to be performed in poorly illuminated or confined workspaces.

2. Description of the Prior Art

The use of hand-held power tools is well-known and such tools are widely used both commercially and in the home. For example, a large variety of tools including drills, screwdrivers, sanders, polishers are available to the professional and home craftsman. One of the problems associated with the use of hand-held power tools is working in poorly illuminated or confined workspaces.

In order to work in poorly illuminated or confined workspaces, it is known to attach a light to a hand-held power tool. For example, U.S. Pat. No. 6,616,295 to Sako et al., entitled “Lighting Devices for Power Tools,” discloses a lighting device including a mount to be attached to a power tool. A flexible support extends from the mount and permits the lighting device to be oriented in any direction, thereby providing illumination for the workspace at night or in a dark area.

In some cases, there is a need to view the portion of the tool that is in contact with the workpiece, such as the moving cutting blade of a hand-held power tool, especially in confined workspaces. In this case the proper alignment of the tool can be difficult to achieve the desired cut. Viewing windows are known for allowing an operator to see the moving cutting tool of a hand-held power tool. In U.S. Pat. No. 6,276,064 to Campbell, entitled “Viewing Window for Saw Guard and Method for Making Same,” a window area for a power tool that allows viewing of the cutting tool is disclosed, however, there is no provision for magnification of the cutting tool or workspace.

In many cases, however, working in poorly illuminated or confined workspaces is rendered even more difficult if the workpiece on which the work is being done is very small or the operator has less than perfect vision. In these cases, the use of magnifying glasses or corrective lenses may be required by the operator. Inconvenience and poor quality of work may result if such glasses or corrective lenses are not readily available.

Accordingly, there is a need for a magnification apparatus that provides magnification of the tool and workspace, that is adjustable, and that can be used with a variety of hand-held power tools and attachments.

### SUMMARY OF THE INVENTION

The present invention is directed to a magnification apparatus that provides magnification of the tool and workspace, that is adjustable, and that can be used with a variety to hand-held power tools and attachments.

In a first embodiment of the present invention, a magnifying apparatus is attached to a hand-held power tool to provide an operator with a magnified view of the tool and workspace. The magnification apparatus is attached to a slot using an adjustable friction mechanism that provides for an adjustment of the focus of the maginification apparatus. A tilt mechanism is included that maintains the tool and workspace in the lens' field-of-view as the magnifying apparatus is moved along the slot. This allows the operator to adjust the focus and magnification, thus allowing the clear viewing of the tools and workspace.

In a second embodiment of the present invention, the magnifying apparatus further includes a light for providing illumination in addition to magnification. The addition of the light in combination with the magnification apparatus increases the ability of the operator to view the tool and workspace, particulatly in those cases where the workspace has poor ambient illumination.

In both the first and second embodiments, the magnification apparatus is mounted to the hand-held power tool in a manner that provides for adjustment of the field-of-view and focus. These adjustments provide for the use of a variety of tools and also compensates for the specific vision of the operator.

Further features and advantages of the present invention will be appreciated by a review of the following detailed description of the preferred embodiments taken in conjunction with the following drawings.

### BRIEF DESCRIPTION OF THE DRAWINGS

The present invention may be best understood by referring to the following detailed description of the preferred embodiments and the accompanying drawings, wherein like numerals denote like elements and in which:

FIGS. 1a and 1b shows a hand-held power tool 100 that includes a magnification apparatus 102 constructed in accordance with a first embodiment of the present invention;

FIG. 2 shows a slot and adjustment mechanism 200 for attaching magnification apparatus 102 to hand-held power tool 100; and

FIG. 3 shows a magnification apparatus 300 that further includes a light source 302 constructed in accordance with a second embodiment of the present invention.

### DETAILED DESCRIPTION OF THE PREFERRED EMBODIMENTS

The following exemplary discussion focuses on a novel magnification apparatus for use with a hand-held power tool, that provides magnification of the tool and workspace, that is adjustable, and that can be used with a variety to hand-held power tools and attachments.

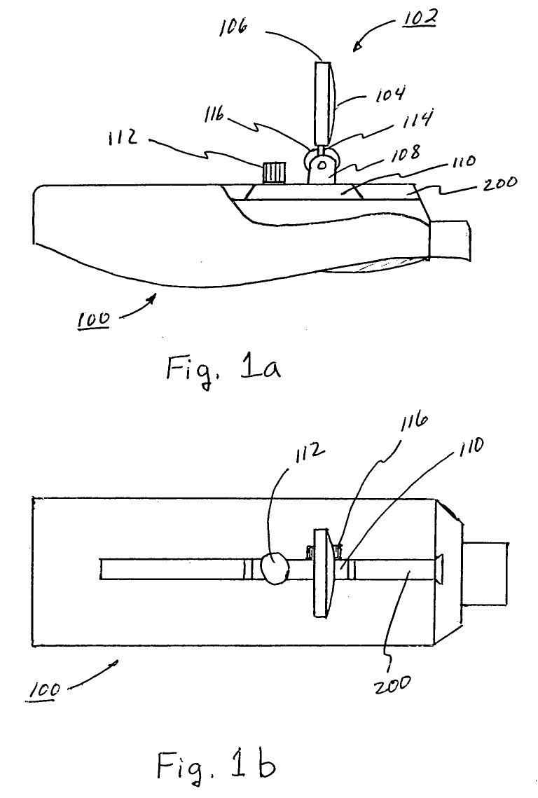

Referring to FIG. 1, a hand-held power tool 100 that includes a magnification apparatus 102 constructed in accordance with a first embodiment of the present invention is shown. Power tool 100 may be any of a number of conventional hand-held tools used for drilling, cutting, sanding, or driving fasteners such as screws, bolts, or nails. Power tool 100 may be powered either by line voltage or battery.

For example, hand-held power tool 100 may be be an electric drill of the type available from one of a number of manufacturers. Magnification apparatus 102 can be attached to the top of the electric drill along the long axis, thereby allowing adjustment of the precise distance between the workpiece and magnification apparatus 102. When this distance is compatible with the distance from magnification apparatus 102 to the operator's eye, the workpiece is brought into focus.

Magnification apparatus 102 further comprises a magnifying lens 104, a support ring 106, and a mounting bracket 108 including a beveled tongue 110 and first friction adjustment 112. Mounting bracket 108 is attached to support ring 106 by a tilt mechanism 114 that includes a second friction adjustment 116. Magnifying lens 104 is a conventional convex lens having first and second focal lengths that are compatible with the length of power tool 100 and the average distance from the magnifying lens 104 to the operator's eye. The combination of support ring 106, mounting bracket 108, and tilt mechanism 114 allow magnification lens 104 to be flexibly positioned along hand-held power tool 100 between the workspace and the operator's eye, while maintaining the workspace in the lens field-of-view, so as to magnify the work being performed.

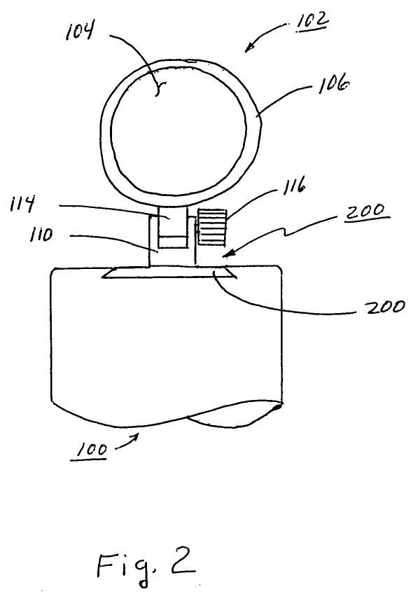

Referring now to FIGS. 1 and 2, a slot 200 and adjustment mechanism for receiving beveled tongue 110 is shown. Slot 200 is preferably located on the top of hand-held power tool 100 and is oriented parallel to the long axis of the tool. Beveled tongue 110 fits into slot 200 and allows the magnification apparatus 102 to slide along slot 200, thereby allowing the focus of magnifying lens 104 to be continuously adjusted. First friction adjustment 112 allows magnification apparatus 102 to be locked in place once the desired focal position has been reached.

Magnification apparatus 102 may be preferably used as follows. The operator first adjusts the position of magnification apparatus 102 along the long axis of hand-held power tool 100 by sliding mounting bracket 108 along slot 202 until the desired position is reached. First friction adjustment 112 is then tightened to lock magnification apparatus 102 at that position. Support ring 106 is then tilted using tilt mechanism 114 until the workspace is within the field-of-view of magnifycing lens 104. Second friction adjustment 116 is then tightened and magnifying apparatus 102 is then in position for use.

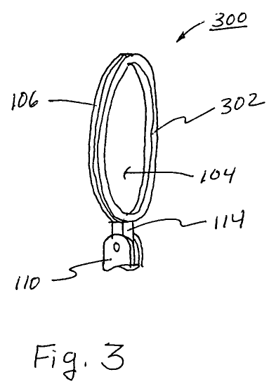

FIG. 3 shows a magnification apparatus 300 that further includes a light source 302 constructed in accordance with a second embodiment of the present invention. In the preferred embodiment, light source 302 comprises a fluorescent ring that is attached to the circumference of support ring 106 of magnification apparatus 102. Alternatively, light source 302 may comprise an incandescent light or solid-state light source, again attached to the edge of support ring 106. In either case, attaching light 302 to support ring 106 will provide an easy means for directing the light toward the workspace.

The foregoing description includes what are at present considered to be preferred embodiments of the invention. However, it will be readily apparent to those skilled in the art that various changes and modifications may be made to the embodiments without departing from the spirit and scope of the invention. For example, the number and type of friction mechanisms may be changed. Accordingly, it is intended that such changes and modifications fall within the spirit and scope of the invention, and that the invention be limited only by the following claims.

1. A magnification apparatus for a hand-held power tool comprising:
a lens; and
a support means for holding said lens, said support means connecting said lens to said hand-held power tool;
whereby said lens provides a magnified view of a workspace of said hand-held power tool.

2. The magnification apparatus of claim 1, wherein said lens further comprises a field-of-view determined by a first focal length and a second focal length, said first focal length and said second focal length for providing said magnified view of said workspace of said hand-held power tool.

3. The magnification apparatus of claim 1 or 2, wherein said support means further comprises:
a support ring containing said lens;
a tilt mechanism connected to said support ring, said tilt mechanism for adjusting an angle of said lens with respect to said hand-held power tool; and
a mounting bracket connected to said tilt mechanism, said mounting bracket for providing a sliding connection between said support ring and said hand-held power tool.

4. The tilt mechanism of claim 3, further comprising a first friction adjustment connected to said tilt mechanism, said first friction adjustment for fixing said angle of said lens, thereby maintaining said workspace within said field-of-view of said lens.

5. The tilt mechanism of claim 4, wherein said first friction adjustment further comprises a screw-operated clamping means.

6. The mounting bracket of claim 3, further comprising a second friction adjustment connected to said mounting bracket, said second friction adjustment for fixing a position of said lens along a long axis of said hand-held power tool, thereby providing said magnified view of said workspace.

7. The mounting bracket of claim 6, wherein said second friction adjustment further comprises a screw-operated clamp.

8. A magnification apparatus for a hand-held power tool comprising:
a lens, said lens having a field-of-view determined by a first focal length and a second focal length;
a support ring containing said lens;
a tilt mechanism connected to said support ring, said tilt mechanism for adjusting an angle of said lens with respect to said hand-held power tool; and
a mounting bracket connected to said tilt mechanism, said mounting bracket for providing a sliding connection between said support ring and said hand-held power tool;
whereby said lens provides a magnified view of a workspace of said hand-held power tool.

9. The tilt mechanism of claim 8, further comprising a first friction adjustment connected to said tilt mechanism, said first friction adjustment for fixing said angle of said lens, thereby maintaining said workspace within said field-of-view of said lens.

10. The tilt mechanism of claim 9, wherein said first friction adjustment further comprises a screw-operated clamping means.

11. The mounting bracket of claim 8, further comprising a second friction adjustment connected to said mounting bracket, said second friction adjustment for fixing a position of said lens along a long axis of said hand-held power tool, thereby providing said magnified view of said workspace.

12. The mounting bracket of claim 11, wherein said second friction adjustment further comprises a screw-operated clamp.

13. A hand-held power tool comprising:
a lens having a field-of-view determined by a first focal length and a second focal length, said first focal length and said second focal length for providing said magnified view of said workspace of said hand-held power tool; and
a support means for holding said lens, said support means further comprising a support ring containing said lens, a mounting bracket connected to said support ring, said mounting bracket for providing a rotatable connection to said support ring, and said support means further comprising first and second friction adjustments connected to said mounting bracket, said first and second friction adjustments for positioning and rotating said lens of said hand-held power tool;
whereby said lens provides a magnified view of a workspace of said hand-held power tool.

14. The magnification apparatus of claim 13, wherein said support means further comprises a tilt mechanism connected to said support ring, said tilt mechanism for adjusting an angle of said lens with respect to said hand-held power tool.

15. The tilt mechanism of claim 13, wherein said first friction adjustment further comprises a screw-operated clamping means.

16. The mounting bracket of claim 13, wherein said second friction adjustment further comprises a screw-operated clamp.

17. The tilt mechanism of claim 14, wherein said first friction adjustment further comprises a screw-operated clamping means.

18. The mounting bracket of claim 14, wherein said second friction adjustment further comprises a screw-operated clamp.

19. A magnification apparatus for a hand-held power tool comprising:
a lens, said lens having a field-of-view determined by a first focal length and a second focal length;
a support ring containing said lens;
a tilt mechanism connected to said support ring, said tilt mechanism further comprising a first friction adjustment connected to said tilt mechanism, said first friction adjustment for fixing said angle of said lens, thereby maintaining said workspace within said field-of-view of said lens; and
a mounting bracket connected to said tilt mechanism, said mounting bracket further comprising a second friction adjustment connected to said mounting bracket, said second friction adjustment for fixing a position of said lens along a long axis of said hand-held power tool;
whereby said lens provides a magnified view of a workspace of said hand-held power tool.

20. The tilt mechanism of claim 19, wherein said first friction adjustment further comprises a screw-operated clamping means.

21. The mounting bracket of claim 19, wherein said second friction adjustment further comprises a screw-operated clamp.

22. A magnification apparatus for a hand-held power tool comprising:
a lens; and
a support means for holding said lens, said support means connecting said lens to said hand-held power tool; and
a light attached to said support means;
whereby said lens provides a magnified view of a workspace of said hand-held power tool, and said light provides for illumination of said workspace.

23. The magnification apparatus of claim 22, wherein said lens further comprises a field-of-view determined by a first focal length and a second focal length, said first focal length and said second focal length for providing said magnified view of said workspace of said hand-held power tool.

24. The magnification apparatus of claim 22 or 23, wherein said support means further comprises:
a support ring containing said lens;
a tilt mechanism connected to said support ring, said tilt mechanism for adjusting an angle of said lens with respect to said hand-held power tool; and
a mounting bracket connected to said tilt mechanism, said mounting bracket for providing a sliding connection between said support ring and said hand-held power tool.

25. The tilt mechanism of claim 24, further comprising a first friction adjustment connected to said tilt mechanism, said first friction adjustment for fixing said angle of said lens, thereby maintaining said workspace within said field-of-view of said lens.

26. The tilt mechanism of claim 25, wherein said first friction adjustment further comprises a screw-operated clamping means.

27. The mounting bracket of claim 24, further comprising a second friction adjustment connected to said mounting bracket, said second friction adjustment for fixing a position of said lens along a long axis of said hand-held power tool, thereby providing said magnified view of said workspace.

28. The mounting bracket of claim 25, wherein said second friction adjustment further comprises a screw-operated clamp.

29. The magnification apparatus of claim 22, wherein said light further comprises a fluorescent ring.

30. The magnification apparatus of claim 22, wherein said light further comprises an incandescent source.

31. A hand-held power tool comprising:
a lens having a field-of-view determined by a first focal length and a second focal length, said first focal length and said second focal length for providing said magnified view of said workspace of said hand-held power tool; and
a support means for holding said lens, said support means further comprising a support ring containing said lens, a mounting bracket connected to said support ring, said mounting bracket for providing a rotatable connection to said support ring, and said support means further comprising first and second friction adjustments connected to said mounting bracket, said first and second friction adjustments for positioning and rotating said lens of said hand-held power tool; and
a light attached to said support means, said light for illuminating a workspace of said hand-held power tool;
whereby said lens provides a magnified view of said workspace of said hand-held power tool.

32. The magnification apparatus of claim 31, wherein said support means further comprises a tilt mechanism connected to said support ring, said tilt mechanism for adjusting an angle of said lens with respect to said hand-held power tool.

33. The tilt mechanism of claim 31, wherein said first friction adjustment further comprises a screw-operated clamping means.

34. The mounting bracket of claim 31, wherein said second friction adjustment further comprises a screw-operated clamp.

35. The tilt mechanism of claim 32, wherein said first friction adjustment further comprises a screw-operated clamping means.

36. The mounting bracket of claim 32, wherein said second friction adjustment further comprises a screw-operated clamp.

37. The magnification apparatus of claim 31, wherein said light further comprises an incandescent source.
